(19) United States
(12) Patent Application Publication
(10) Pub. No.: US 2004/0219494 A1
(43) Pub. Date: Nov. 4, 2004

(54) Authoring tool and method of use

(76) Inventor: John F. Boon, Washington, DC (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/772,449

(22) Filed: Feb. 6, 2004

Related U.S. Application Data
(63) Continuation-in-part of application No. 10/237,044, filed on Sep. 9, 2002.
Application No. 10/237,044 is a continuation of application No. 09/455,160, filed on Dec. 6, 1999, now Pat. No. 6,447,299.
Application No. 09/455,160 is a continuation of application No. 09/042,635, filed on Mar. 17, 1998, now Pat. No. 6,022,221.
(60) Provisional application No. 60/042,326, filed on Mar. 21, 1997.
(60) Provisional application No. 60/445,235, filed on Feb. 6, 2003.

(51) Int. Cl. G09B 19/00

(52) U.S. Cl. 434/156

(57) ABSTRACT

An authoring tool and method of use that allows the user to create sets of target multimedia learning material for use in computer-assisted education and computer-based training. The tool include a series of prompts to guide the user through the process, algorithms for the format of the material into a usable a form for various systems, and required database structure with populated tables. One variation includes two distinct features, including Talking Photo Software and Smart Cards. The authoring tool enables any user to create Talking Photos, by enabling the user to gather, collate and correlate multimedia assets for storage and retrieval. The authoring tool also enables any user similarly to create Smart Cards, which include features for determination of review timing, sequence and presentation modes, dependant on user profiles, which are based on data integral software developed over time, indicating which specific learning elements to target.

This application is a continuation-in-part of applicant's copending U.S. patent application Ser. No. 10/237,044, titled “METHOD AND SYSTEM FOR SHORT-TO LONG-TERM MEMORY BRIDGE” filed Sep. 9, 2002, which is a continuation of applicant's copending U.S. patent application Ser. No. 09/455,160 filed Dec. 6, 1999, now issued as U.S. Pat. No. 6,447,299, which is a continuation of applicant's U.S. patent application Ser. No. 09/042,635 filed Mar. 17, 1998, now issued as U.S. Pat. No. 6,022,221 on Feb. 8, 2000, and which claimed the benefit of U.S. Provisional Application No. 60/042,326, filed Mar. 21, 1997. This application also claims priority to applicants' copending U.S. Provisional Patent Application Serial No. 60/445,235 titled “AUTHORING TOOL AND METHOD OF USE” filed Feb. 6, 2003. The entirety of each of these applications is hereby incorporated by reference.

### BACKGROUND OF THE INVENTION

1. Field of the Invention

The present invention relates to a method and system for providing interactive tutoring and memory training and related features, and in particular, the present invention relates to a method and system for enhanced learning, including an authoring tool usable with the method and system and for other purposes.

2. Background of the Technology

Many computer-based teaching machine designs store questions or problems to present to the user as prompts for the correct answer or solution. The user's responses are evaluated by comparison to the stored answer, and in the more sophisticated machines, the process control is influenced by the evaluation. However, existing art has a number of weaknesses. Existing art requires the user to respond with complete answers. Existing art informs the user that an incorrect answer was incorrect without informing the user exactly what was incorrect about the answer; the user often cannot identify exactly what was incorrect about the answer. Existing art normally responds to correct answers by immediately presenting the next answer. The previous correct answer disappears. Thus the user could have guessed the correct answer without actually knowing what it was, or immediately forgotten what the correct answer was. In addition, existing art merely processes answers as either correct or incorrect.

U.S. Pat. No. 5,540,589 to Waters, titled Fault-tolerant Audio Interactive Tutor, attempts to address some of the problems of the existing art by considering answers to be correct if they are close enough, and U.S. Pat. No. 5,577,919 to Collins, et al., attempts to solve problems of the existing art by seeking to determine not whether the answer is correct or not, but merely whether the user thinks the answer is correct. Neither of these approaches attempts to deal with partially correct answers.

Other problems of existing art include the fact that existing art does not make use of subliminal suggestion to prompt the user with the correct answer. Further, existing art does not present the user with prior errors. In addition, importantly, existing art does not attempt to deal with the problem of graded interval recall taking actual elapsed real time into consideration. Material is reviewed on the basis of correctly/incorrectly answered priority, the most crude form of which is simply to repeat incorrectly answered questions. Attempts to prioritize the sequence of material on a more intelligent basis (see, U.S. Pat. No. 4,193,210 to Turnquist) can result in delays of reviews until long after the material has been lost from short-term memory.

Similar problems exist with other learning methods and systems, such as existing electronic flash card technology. For example, existing electronic flash card technology represents no significant improvement over paper flash card functionality. Existing technology only allows one to read the question side of a flash card, optionally click a mouse to read the answer side, proceed forwards, backwards, or perhaps randomly proceed through the set. One can repeat the process. The more sophisticated embodiments of prior art might sort the set into groups, such as correctly answered and incorrectly answered cards. All of this can be done easily with traditional, paper flash cards.

### SUMMARY OF THE INVENTION

It is an advantage of the present invention to overcome the problems of the existing art by creating a method and system that provides a short- to long-term memory bridge and a supporting authoring tool. It is an advantage of the present invention to solve the problem of excessive repetition by requiring the user is required to respond with only the part of the answer not yet correctly entered.

It is an advantage of the present invention to solve the problem of users guessing the correct answer without actually knowing what it was, or immediately forgetting what the correct answer is by showing the previous correct answer on the screen for the user's reference. This feature reinforces the correct answer in the user's memory.

It is an advantage of the present invention to solve the problem of a user being unable to make use of their prior errors by presenting the user with prior errors a given question for material that is determined to be not very well known by the user. This serves as a reference for the user to learn not to repeat previous errors.

It is an advantage of the present invention to solve the problem of graded interval recall by periodically reviewing each element of material according to the proven length of retention the user has for that element. Reviews are timed according to graded interval recall by a computation that takes into account the exact real time and date when the user first learned the element. Furthermore, it is an advantage of the present invention to use default sequencing of material in which material is interrupted by a special array, which stores the material that has been learned and when. After a pre-set interval, (e.g. twenty minutes), a period after which the user is most likely to forget, the material is reviewed, thereby bridging the gap between short-term and long-term memory.

The Smart Card technology of the present invention provides at least two additional major improvements over the prior art. First, the user can interactively input an answer to the question “What is on the other side of the card?” simply by clicking the mouse, by speaking the answer into a microphone, or by other input. The answer is then processed by voice recognition or other appropriate software built into the Smart Card technology. Each answer is evaluated and stored by the Smart Card technology as data. This data is evaluated to determine the timing and sequence of subsequent iterations. Another use of this data is to adjust the scope of the material presented by the cards.

One embodiment of the present invention includes a series of flow charts automatically implemented, such as on any general-purpose computer, including “personal” microcomputers. Those skilled in the art will recognize that the same logic used for written questions/written answers can also be used in, but not limited to audio questions and aural responses (i.e., in study of pronunciation and elocution), as well as graphics and other graphical user interface (GUI) systems (e.g., in the study of anatomy or other charts to which the user responds by pointing and clicking on the response with a mouse).

An embodiment of the present invention carefully times and tracks the user's progress without exerting any pressure or rushing the user. The present invention stores the time and date when the user learns an answer, and the amount of time elapsed from that date is used to determine the presentation of the material and the schedule of reviews.

The program logic of the present invention reviews material that has been retained for a preset time (e.g., twenty minutes) so that the material in the user's short-term memory becomes ingrained in the user's long-term memory. The present invention tracks the user's progress on each memory item over time in exact detail with a gradation of retention levels.

An embodiment of the present invention includes a database with records containing problems or questions with their correct answers or responses. A field in each record stores a value used to indicate the level of retention the user has for each question/answer pair. This value is used to determine the display and response mode for each record. The display and response modes require greater retention as the material becomes more familiar. Conversely, display and response modes again become easier for question/answer pairs that the user has forgotten. Thus the retention value is constantly adjusted to reflect the user's performance.

The present invention also includes an authoring tool usable with the prompt and response system to allow tailoring of subject matter for the prompts and for other purposes. Currently, user authoring of computer-based training (CBT) is primitive, consisting merely of input of question-answer pairs. Authoring of more sophisticated CBT containing multimedia assets is generally unavailable to the general user (e.g., teachers, students), and is created, if at all, in professional software shops. Users (e.g., teachers, students) often find that even in the extremely rare case of CBT that is otherwise adequate, they are unable to create, edit, modify or add to the given subject material to accommodate their specific needs. The Authoring Tool and Method of Use provides users with that capability.

Additional advantages and novel features of the invention will be set forth in part in the description that follows, and in part will become more apparent to those in the art upon examination of the following or upon learning by practice of the invention.

### BRIEF DESCRIPTION OF THE FIGURES

In the drawings:

FIG. 1 depicts an overview of various components for use in implementation of one embodiment of the present invention;

FIG. 2 presents components for use of the present invention via a network, such as the Internet or an intranet;

FIG. 3 shows the various components of an example computer system usable in accordance with embodiments of the present invention;

FIG. 4 contains a representative diagram of exemplary input, process function, and output devices, in accordance with an embodiment of the present invention;

FIG. 5 is a first exemplary graphical user interface (GUI) screen for use in accordance with an embodiment of the present invention;

FIG. 6 is a second exemplary graphical user interface (GUI) screen for use in accordance with an embodiment of the present invention;

FIG. 7 is a flowchart of an authoring tool process, in accordance with one embodiment of the present invention;

FIG. 8 is a flowchart of an electronic smart card feature, in accordance with an embodiment of the present invention;

FIGS. 9 and 10 present example GUI screens for a Smart Cards feature in operation, in accordance with an embodiment of the present invention; and

FIG. 11 shows an example GUI screen for a Talking Photo Software (TPS) feature, in accordance with an embodiment of the present invention.

### DETAILED DESCRIPTION

The present invention provides teaching method and system that presents queries to a user who responds with answers and authoring tool and additional features relating thereto.

Underlying Query System

As discussed further in applicant's copending applications and previously issued patents, which are incorporated herein as indicated above, an embodiment of the present invention includes a series of flow charts automatically implemented, such as on any general-purpose computer, including “personal” microcomputers. Those skilled in the art will recognize that the same logic used for written questions/written answers can also be used in, but not limited to audio questions and aural responses (e.g., in study of pronunciation and elocution), as well as graphics and other GUI systems (e.g., in the study of anatomy or other charts to which the user responds by pointing and clicking on the response with a mouse).

An embodiment of the present invention carefully times and tracks the user's progress without exerting any pressure or rushing the user. The present invention stores the time and date when the user learns an answer, and the amount of time elapsed from that date is used to determine the presentation of the material and the schedule of reviews.

The program logic of the present invention reviews material that has been retained for a preset time (e.g., twenty minutes) so that the material in the user's short-term memory becomes ingrained in the user's long-term memory. The present invention tracks the user's progress on each memory item over time in exact detail with a gradation of retention levels.

An embodiment of the present invention includes a database with records containing problems or questions with their correct answers or responses. A field in each record stores a value used to indicate the level of retention the user has for each question/answer pair. This value is used to determine the display and response mode for each record. The display and response modes require greater retention as the material becomes more familiar. Conversely, display and response modes again become easier for question/answer pairs that the user has forgotten. Thus the retention value is constantly adjusted to reflect the user's performance.

In an embodiment of the present invention, the letter “Q” represents this value for the purposes of this document. Q is initially set to 1, corresponding to the EASY display mode, where the answer is shown with the question for the user to copy. When this is successfully accomplished, Q is set to 2 for that record, corresponding to the LEARN display mode.

When the user correctly responds to a question displayed in LEARN mode, the Q is set to 3 and the date and time are saved. The item is displayed in QUICK mode in its turn for amount of time associated with the Q level. When Q reaches 3, the material is shown to the user in order to be fresh in the user's short-term memory. The time and date of this event is stored in the database in the field named “G-time.” When this happens, an element is also added to an array, which includes the time, date, and record number when this occurs.

In an embodiment of the present invention, reviews are timed by an algorithm that uses three factors so that the reviews occur as close as possible to the threshold at which memory items are most likely to be conducted from short-term into long-term memory (e.g., from five to a maximum of twenty minutes). These three factors are: 1) the value of Q (1-14), ranging from one, denoting unknown or forgotten material, and 14 for material that has been correctly remembered for thirty days or more; a Q value of 6, for example, corresponds to a retention time of at least ten minutes; 2) the actual length of time elapsed since the record was learned (time elapsed from the time that Q reached three); this time is calculated by comparing the G-Time (e.g., the stored time and date stamp of the event when the Q reaches the value of three), with the system time (e.g., today's date and time in the computer); this difference between the two times is named ‘E-Time’; and 3) a third factor is looked up in the table that correlates each possible value of Q (1-14) to a specific length of time (e.g., five seconds to thirty days.)

Reviews are thus triggered by expiration of the duration of time associated with the query and answer pair's Q. Similarly, reviews are also triggered by expiration of the time in the array ARRAY-G. This ensures that no reviews are delayed past the cutoff time because of time taken up by displays of other material.

Thus, reviews come progressively less frequently with longer retention (greater Q). Q and E-time are also used to determine how much to increment a word's Q is after a review. All of this takes place in the logic called “Get Word Profile.”

Incorrect answers in a review cause the Q for that question/answer pair to be reset to two, corresponding to the LEARN display mode. When this happens, the learning cycle for the record restarts. When the value of Q again reaches three, the base date for timing reviews (G-time) is also reset, thus initiating a fresh review schedule.

The present invention eliminates redundancy. Once a word or phrase has been remembered correctly, it retires to a status that brings it to the user's attention only passively until time indicated by the Q level elapses, triggering a review. Thus, the longer the user remembers an item, the less frequent the review of that item. Until a review is scheduled, intermittent displays of the item are in the QUICK mode, in which the question is displayed on the screen in its turn along with the answer; however, this display is a passive mode, for progressively shorter durations approaching subliminal speeds. If a review shows that a word or phrase has been forgotten, the program brings the word back into an active learning mode for more attention.

In an embodiment of the present invention, there is no need for the user to guess what was incorrect about an incorrect response, because it is displayed on the screen with a pointer pointing to the error. An incorrect response automatically induces a hint, wherein the correct part of the answer plus the next letter of the unknown part of the answer is displayed on the response line. Incorrect responses and their dates are also saved for optional display on successive iterations.

Correct answers that were not correct on the first attempt are also shown on the screen for a few moments for reference and reinforcement. Correct answers optionally can appear on the answer line quickly as a subliminal suggestion.

Other variables are stored in a second database structure called SYS. These variables include preset timers for the previews and for quick displays, sound on/off toggle, parameters for determining the sequence of lessons (same, previous, or next), and whether or not the records are displayed in random sequence within better-known lessons.

Optimal review schedules are specifically timed in the present invention to bridge the threshold between short-term and long-term memory.

In an embodiment of the present invention, the vocabulary databases are modular, replaceable, and user-selectable and may be edited or added to by a system administrator familiar with the meaning of the data structures.

An embodiment of the present invention has alternate versions of the Q-time table dynamically activated depending on a number of factors, which include the user's learning profile, configuration settings, and internal logic. Alternate timers have less intensity (less frequent review) and fault-tolerant comparison analysis, while other more rigorous timers resume control when the user is progressing (remembering) well. Databases containing literature in various languages, language spoken by native speakers of various languages, and graphics databases for study of anatomy and astronomy are included in an embodiment of the present invention.

References will now be made in detail to embodiments of the present invention, examples of which are illustrated in the accompanying drawings.

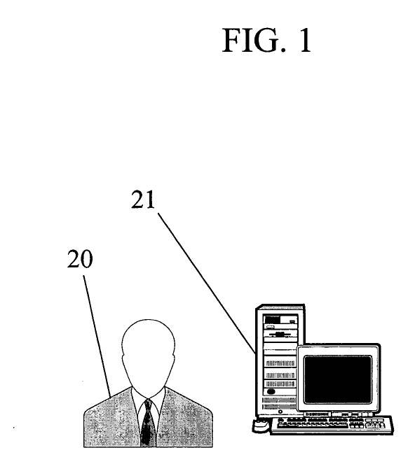

FIG. 1 depicts the various components for use in implementation of an embodiment of the present invention. As shown in FIG. 1, in this embodiment, a player 20 plays at a terminal 21, such as a personal computer, a minicomputer, a microcomputer, a main frame computer, or other device having a display, processor and GUI.

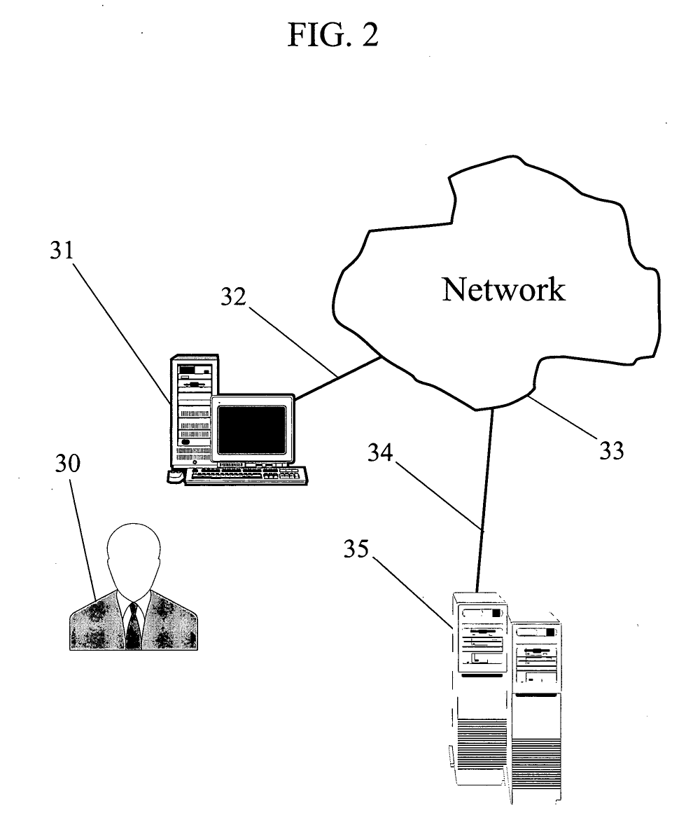

FIG. 2 presents components for use of the present invention via a network, such as the Internet or an intranet. As shown in FIG. 2, a player 30 plays at a terminal 31, such as a personal computer, a minicomputer, a microcomputer, a main frame computer, or other device having a display and processor. The terminal 30, is connected 32, 34, for example, via wired, wireless, or fiber optic coupling, and a network 33, such as the Internet or an intranet, to a server 35, such as personal computer, a minicomputer, a microcomputer, a main frame computer, or other device having a processor.

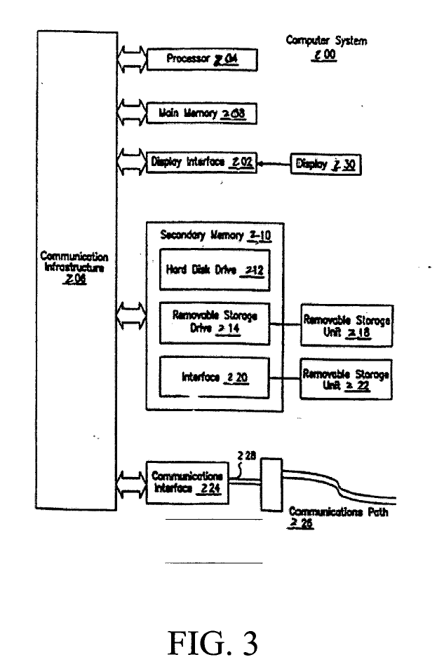

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 3.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Embodiments of the present invention further include additional features relating to prompts and responses, artificial intelligence, and authoring tools, as will be described further below.

Embodiments of the present invention include numerous types of more sophisticated prompts and responses. One of the types of prompts and responses is a multiple choice type, which contains some similar functions to a standard multiple choice test. In this embodiment, the prompt includes possible answers, and the user picks among the answers provided, in a similar manner to how a user would respond to a standard multiple choice test.

A second variation is a “line by line” type of prompt and response, in which the purpose, for example, is to memorize a continuing passage, such as a sonnet, a sermon, or a speech. This variation is generally applicable to any memorization that is linear or otherwise similar to a narrative. This variation operates as follows: a prompt provides an initial line of the text, with the answer being the second line. In succession, the second line becomes the prompt for an answer that is the third line. The text then continues in a chain-like manner until the passage is complete.

In another variation, graphics prompts are provided in conjunction with text responses. For example, if an image of a painting is provided as the prompt, and the response to be provided is the name of the painter. This variation also has many other applications. For example, images and responses are usable to train pilots to recognize airports. Pilots need to know what an airport looks like from the air, including, for example, which runways are which. Graphical and text prompts and responses are useful in drilling pilots to recognize these features. Another example application is for sports. Such graphic and text drilling is useful to learn, for example, plays in football playbooks.

The third variation includes audio prompts, which are particularly useful, for example, with language tapes, as this feature allows the user to hear how a word is pronounced or other audio information sounds. In addition, this feature has the advantage of allowing the user to utilize aural memory to reinforce memory in conjunction with seeing the visual image or word. This variation also optionally includes use of voice recognition to provide a vocal response. With this feature, the user is provided with the capability to provide a voice response, and the system uses voice recognition technology to determine whether the answer is correct. With more sophisticated analyses of voice patterns, this feature also has the capability to reinforce the user's memory with respect to accents in foreign languages, such as, for example, regional accents.

Yet another variation includes video prompts and other information. Use of video and sound in conjunction with the prompt enhances memory retention by associating sound and video with the information to be retained. In addition to allowing prompts in video form and responses thereto, video features include, for example, information provided to the user regarding rewards, such as upon finish of a lesson, indicating the user has correctly responded to the entire lesson, and at other points in the system activity where appropriate. In one embodiment, a popup window appears, and an audio visual stream is presented in the window via reading from an electronic or other stored file. Such video includes, for example, a figure congratulating the user in some kind of way. In one embodiment, the user decides who provides the congratulations. For example, the user is able to select from stored video feeds from various celebrities, professional actors, cartoon images, or other presenters.

Sound and video are also usable in conjunction with an embodiment of the present invention to provide additional information to prompts and responses, such as hints and to provide general study enhancement features, such as background music.

Another embodiment of the present invention includes multiple linked prompts, such as prompts linked as part of a video storyline. For example, to learn French vocabulary, the prompter is shown walking in a location having the various vocabulary items to be studied. As each item is shown, it appears in the video so as to link sound, image, and prompt/response. After the initial vocabulary presentation, the system returns to prompts and responses for the vocabulary items learned. The overall linked prompts comprise a lesson. In another example, a lecture on particle physics is presented followed by prompts for responses relating to the lecture.

An embodiment of the present invention includes links, prompts, responses, and times reviews. This embodiment includes artificial intelligence features that vary prompts and other information on a tailored basis, depending on specific user strengths and responses. For example, the system analyzes correct use responses to determine user strengths, such as higher likelihood of correct answers for questions associated with food, mechanical words, nouns, or motion verbs. In another embodiment, user selections for responses are linked to different prompts and analyses, depending on the response selected. For example, each multiple choice answer is linked to a different portion of the system. By selecting the correct response, the user proceeds to the next portion of the lesson. Incorrect responses return the user to various review portions or trigger certain types of review, depending on the answer selected.

Similarly, whole lessons or portions of lessons are linkable by prompts and responses. Thus, for example, during reviews, if it is determined that the user is consistently making errors with regard to a particular previous lesson, the system automatically revisits that lesson for the user's review and reinforcement.

Embodiments of the present invention further incorporate artificial intelligence to enhance learning. One aspect of an embodiment of the present invention is the use of a feature referred to as “Dwell,” which relates to the timing of the prompt and response following the user providing the correct answer to a prompt. In an embodiment of the present invention, upon receiving the correct response, the correct response remains visible to the user for a determined period, such as five to ten seconds. Maintaining the correct answer in this manner enhances user memory by allowing the correct answer to “sink in” or otherwise be reinforced for the user. If the correct answer simply disappears, and the next prompt is immediately presented, the correct response to the answer is quickly forgotten, as no reinforcement occurs.

In an embodiment of the present invention, the length of the dwell time varies depending on the user and circumstances. In one embodiment, the dwell time is initially preset for an optimum period determined for the typical user, such as five seconds. The dwell time is then dynamically varied depending on the performance of the user. For example, if the user demonstrates an ability to remember a correct response after a tenth of a second dwell time, the invention takes advantage of this user capability, so as not to use more time for dwell time. Successively shorter or longer periods of dwell time are used so that users do not waste time on known questions. The A-I portion of the system allows dynamic adjustment of the amount of time the user is provided, depending on, for example, how alert the user appears to be and factors accounting for how secure the particular information is in the user's memory. For example, one embodiment of the present invention includes a variable period for repetition for correctly answered information based on one or more factors, such as the number of times the information was incorrectly answered for the user.

Another feature addressing repetition of missed information addressed by the present invention is the time taken by the user to provide an answer. In an embodiment of the present invention, the amount of time taken by the user in providing an answer affects repetition: for example, if a user repeatedly takes a long time to provide a particular answer, even if provided correctly, the present invention will repeat the query for this answer more frequently than for other answers that are provided correctly, but more quickly.

Yet another feature of the present invention relates to repetition training for specific information, which in one embodiment is referred to as “Drill Mode.” With this feature, the user is repeatedly provided with queries that have been frequently missed so as to “drill in” to the user the correct response.

Authoring Tool

An embodiment of the present invention includes two sections. One section includes a driver, which runs the material presented to the user, and the second section includes the actual content included in what is provided to the user, which resides in its own discreet repository, such as a database. The resository section is readily replaceable by providing an “authoring tool” that allows input and proper formatting of the content. One aspect of the authoring tool of an embodiment of the present invention includes use of a specialized graphical user interface (GUI) to assist the user with input.

An embodiment of the authoring tool of the present invention further includes use of varying levels of user interface, allowing variable use of the authoring tool, depending on user level, as is known in the art. For example, some users may be able to utilize the authoring tool, because of their user level, but others, due to a differing user level, will be unable to use the authoring tool.

Network Variation

An embodiment of the present invention includes network (e.g., Internet) based access for certain system functionality. In one embodiment, a potential user is able to access a demonstration program via a network site, such as a website, and then subscribe to services via the network site using, for example, network payment and ordering systems known in the art. The subscribing user is able to select among subject matter areas for prompts and learning. In one embodiment, a user is allowed to subscribe for a set time period for all subject areas or to subscribe for unlimited (or longer time period) use of a single subject matter area. In an embodiment of the present invention, costs of subscription vary, depending, for example, on the subject matter. Differing subscriptions also allow variability in rights, such as allowing downloads of lessons, if the user pays a higher fee.

In order to control use and limiting copying, etc., an embodiment of network based version of the present invention includes use of passwords or other security mechanisms known in the art.

Authoring Feature for Other Applications

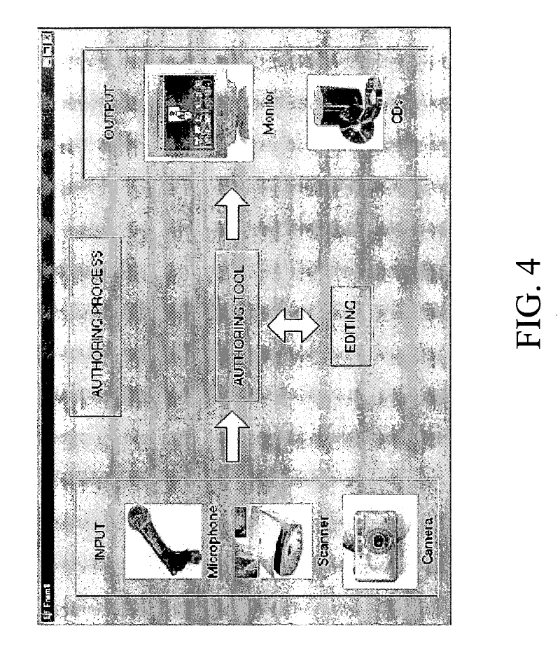

Multimedia assets are collected using input devices shown on the left on FIG. 4. The authoring tool is used to format, edit and arrange the assets and to output the finished product to the monitor (shown here in a web browser viewing a Talking Photo Album) and/or CDs.

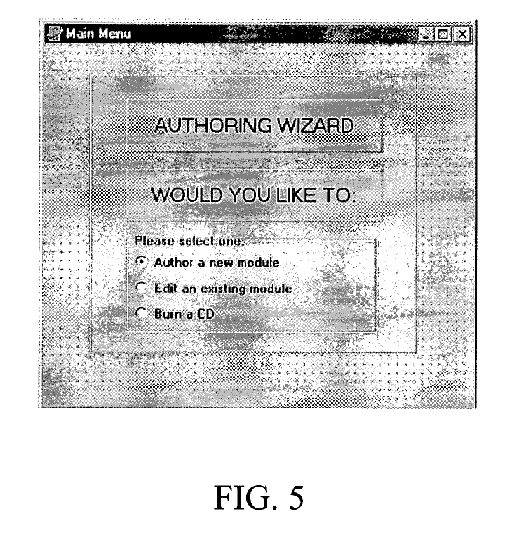

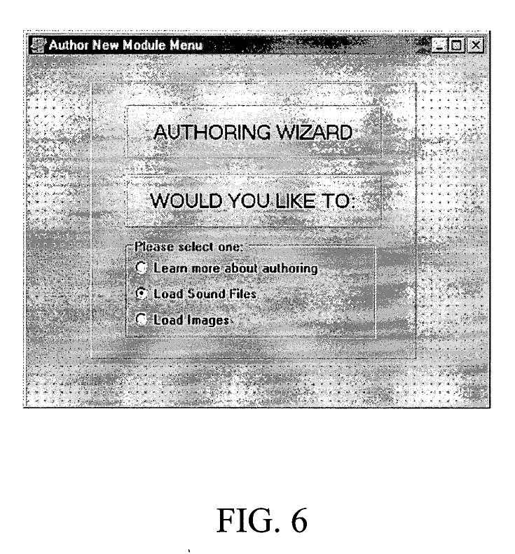

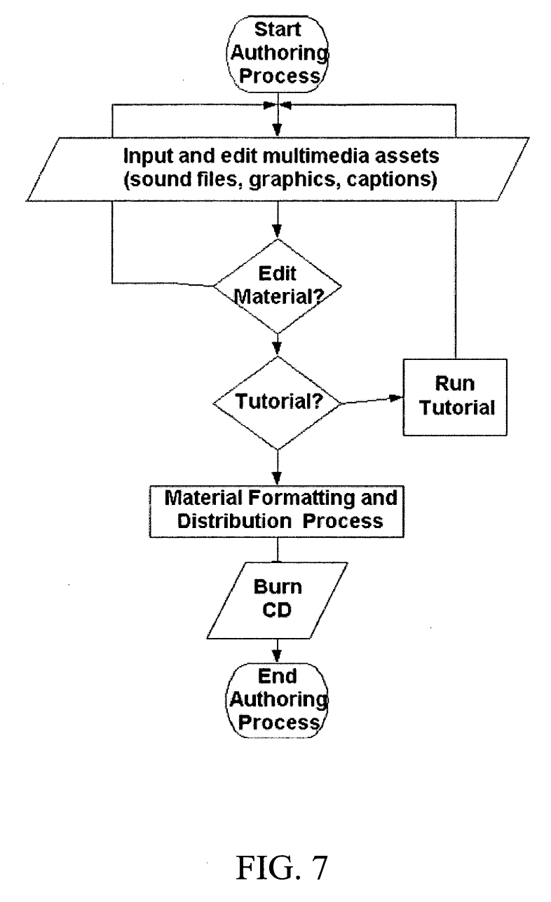

An embodiment of the authoring tool contains a “wizard”. Examples of two possible wizard prompt windows are shown in FIGS. 5 and 6. FIG. 7 shows an overview of the authoring process.

Smart Cards Application. This feature of the present invention (referred to interchangeably herein as the “smart card” technology), which is usable with the authoring process and wizard, promotes a new order of magnitude for efficacy in interactive electronic flash cards. The smart card technology of the present invention has at least two major improvements over the prior art. First, the user can interactively input an answer to the question “What is on the other side of the card?” simply by clicking the mouse, by speaking the answer into a microphone, or by other input. The answer is then processed by voice recognition or other appropriate software built into the Smart Card technology. Each answer is evaluated and stored by the Smart Card technology as data. This data is evaluated to determine the timing and sequence of subsequent iterations. For example, wrong answers are automatically reviewed, either immediately or at timed intervals, and the question is rephrased appropriately according to the given answer.

Another use of this data is to adjust the scope of the material presented by the cards. For example, two users are answering the same alphabet questions, each on his or her own Smart Card server. User A misses half of the questions, while user B answers all but one correctly. The data stored by the Smart Card software causes user A to be presented with a review of the alphabet, whereas user B, after reviewing his or her error(s), is presented with more advanced material, such as the consonant blends. By this process, the Smart Cards presents material specifically optimized to the individual learning characteristics of each user. The process is applicable to a multitude or other subjects (e.g., Smart Cards that expand and collapse the scope in gradients appropriate for anatomy, starting from a grade school level, and progressing to the level appropriate for a medical student).

Multiple choice option. One Smart Card shows the question side of the card near the top of the screen. Below that on the screen, several cards show their answer sides, one of them being the correct answer. The user makes a choice by clicking the mouse or by speaking the answer, which is then processed by built-in voice recognition software. Smart Card software evaluates the answer. Applications for standardized test preparation are obvious. Similarly to the above, the technology can also finesse the presentation to maximize the focus of material according to the user's performance. For example, the set of alternate possible choices for answers can be fine tuned to focus on specific areas of lesser discernment (e.g., the distinction among species of mushrooms with similar appearance, but having widely differing flavors or medicinal properties).

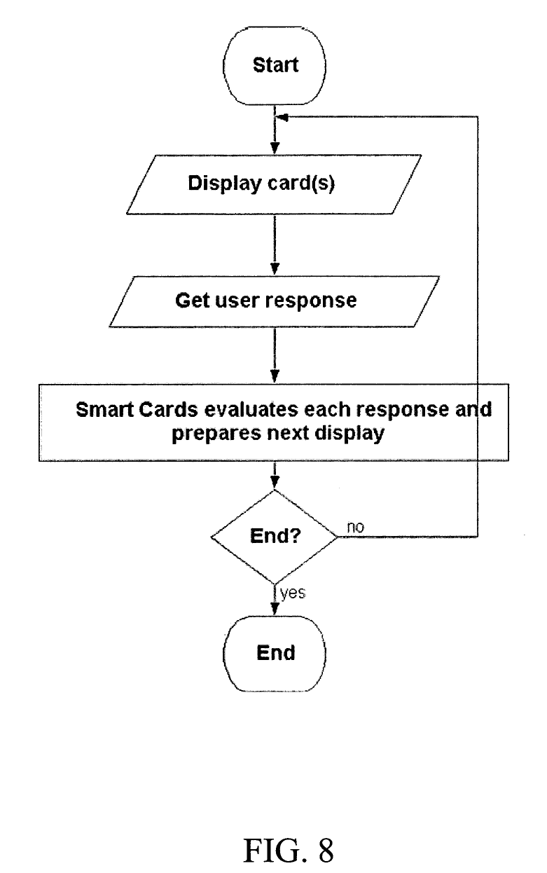

The flowchart of FIG. 8 shows the operational process as a user uses the Smart Cards. Each response of the user triggers an evaluation by the Smart Card software. Built-in algorithms in the Smart Card software configure the subsequent display, depending on the accuracy of the response and other factors, such as whether the user seems to be alert or not, the exact nature of an incorrect response, and/or the demonstrated learning pattern of the individual user.

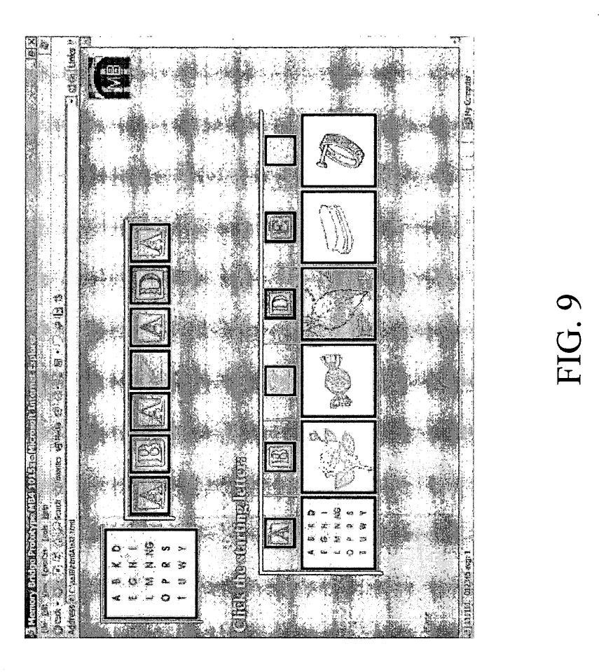

FIG. 9 presents an example screen shot of SmartCards in action at the beginning of a lesson on the first five letters in the Filipino alphabet (ABKDEG), as follows. The audio track and the image in the upper left prompt the user to click on the starting letter (A) of the pictured word, abakada, (alphabet). When the user selects the correct answer, the next Smart Card (showing a bulaklak (flower), starting with the letter ‘B’, is presented.

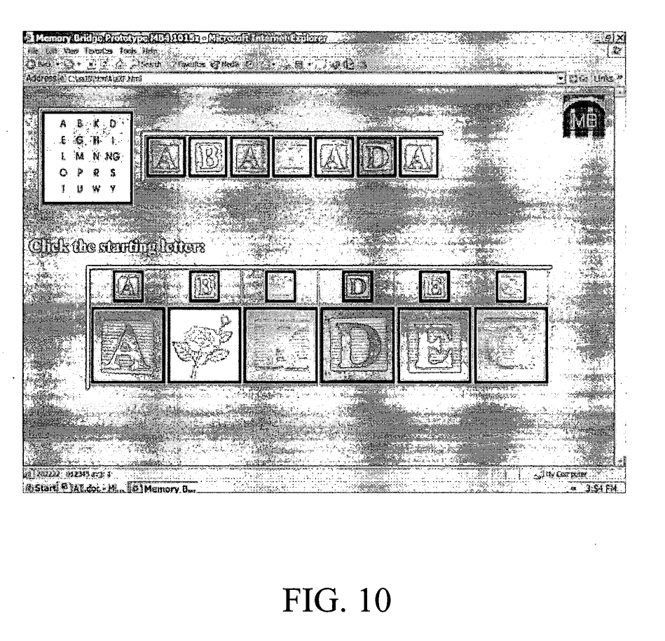

An example screen shot of SmartCards in action on a subsequent iteration is shown in FIG. 10. On the previous iteration, the user has selected the letters correctly except for ‘B’. Accordingly, SmartCards presents the picture of the flower (bulaklak) again, whereas only the letters are presented in the other cases. (The user needs more leading (the picture of the flower) in the case of ‘B’, but less leading (the letter only) in for the other words.

As shown in FIG. 10, the prompts for letters previously correctly selected by the user show only the letter, not the picture. The prompt for the previously incorrectly selected option (the letter B) continues to show the picture. Smart Cards continually presents the material according to the user's selections.

Talking Photos

A feature referred to interchangeably herein as “Talking Photos” is also usable with the authoring process and wizard. This feature provides an interactive multimedia collection of graphic files and sound files stored on electronic media. The authoring tool enables users to assemble and incorporate their own files into individually customized electronic form (interchangeably referred to herein as “Talking Photo Software” or TPS). TPS interactive software displays the graphics and enables any user to select and display each graphic and to play selected sound files associated with each of graphic.

The source of the graphic files can be photographs or drawings that have been scanned, downloaded from a network, or generated on a computer (e.g., any graphic stored in electronic format, such as a bitmap or jpeg). Similarly, the source of the sound files can be prerecorded media, such as videotape, audiotape, or recordings direct to disk (e.g., any sound stored in electronic format such as a .wav or .au file).

TPS authoring can be done locally or remotely (e.g., on location at an event such as a wedding, or over the Internet), by prompting customers to submit images and record the sound files, directly over the Internet, by voice mode telephone, or by electronic or surface mail, edit the package, and run or procure copies of the finished product, such as for a fee.

An example of an application of the TPS is a Talking Photo album of a wedding. The graphics consist of scanned-in images from photographs taken at the wedding. The sound files include taped interviews recorded before, during and after the wedding and sound clips of the wedding itself. Other sound files and graphics include pictures and recordings of family and friends, of music, anecdotes, greetings, blessings and stories (e.g., any available graphic and sound files the author decides to use). The TPS authoring tool assembles and names all the files and prompts the author for optional captions for the graphics, such as “Uncle Joe”, “Cutting the Cake”, or “Baby's First Drawing”. The authoring tool provides for editing and stores the finished product on computer disk. The material can then be transferred to compact disk (CD), for example.

The finished product on CD comprises an indexed permanent record of the wedding. The computer mouse or other input device is used to select any of the photographs from among groups of small images on the screen. The selected photograph appears enlarged on the screen over a caption, and the associated sound file is played over the computer speakers. When the user clicks the enlarged image, a menu appears. By selecting items from the menu, the user hears any of the other embedded sound files associated with the photo, with titles such as “Best wishes from Uncle Joe”, “Baby's first words” or “Grandpa's favorite joke again.” The CD can be duplicated and distributed as a legacy item to preserve the event for all time.

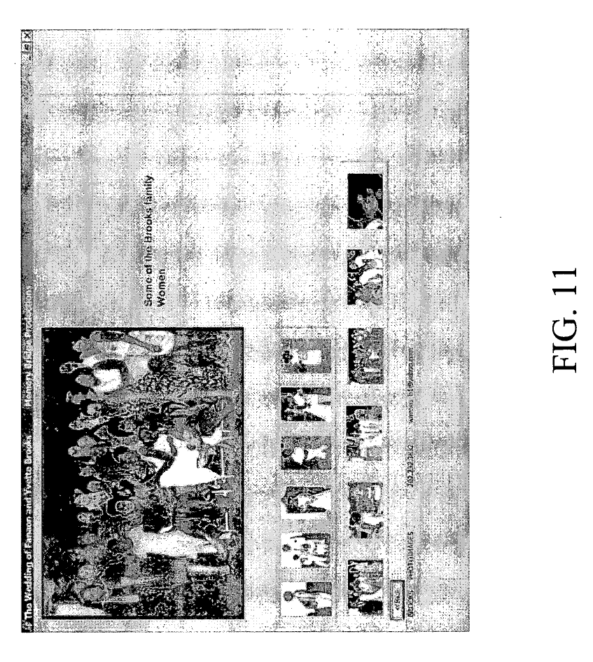

FIG. 11 shows a screen shot of TPS. When the user clicks on an image, the image is enlarged, the main audio file associated with the selected image is played over the system speakers, and the other sound files associated with that image become available as menu selections.

Example embodiments of the present invention have now been described in accordance with the above advantages. It will be appreciated that these examples are merely illustrative of the invention. Many variations and modifications will be apparent to those skilled in the art.

Glossary

“assets”: graphic, video, animation or sound files in computer based format usable on web pages and in interactive multimedia software, for example, ‘.jpeg’ images or ‘.wav’ sound files.

“wizard”: a system of prompts that guide the user through the an otherwise complicated process. A wizard usually consists of a series of on-screen prompts with selectable and text input that the user gives to specify parameters including such as, in this case, the names and locations of the assets and the name of output modules.

1. A method for providing an authoring tool for enhancing long-term memory, the method comprising:
providing a graphical user interface input for receiving content;
receiving the content, the received content including at least one query input and associated response; and
formatting the content for use with a query and response feature;
wherein the query and response feature includes:
providing each of the at least one query, each of the at least one query having an associated memory retention value;
receiving a response to each of the at least one query;
evaluating the response to each of the at least one query; and
updating the associated memory retention value for each of the at least one query based on the response to the evaluated response.

2. The method of claim 1, wherein each of the at least one query comprises a representation of a flash card.

3. The method of claim 1, wherein the at least one query comprises input selected from a group consisting of a graphical prompt, a text prompt, an audio prompt, and a video prompt.

4. The method of claim 1 wherein the at least one query comprises a plurality of linked prompts.

5. The method of claim 1, further comprising:
displaying a correct response to each of the at least one query.

6. The method of claim 5, wherein the correct response is displayed for a variable time period.

7. The method of claim 6, wherein the variable time period dynamically adjusts depending on number of incorrect answers to each of the at least one query received.

8. The method of claim 1, further comprising:
repeating the providing of each of the at least one query at variable intervals, the intervals varying with response time taken for at least one previously received response.

9. The method of claim 2, wherein providing at least one query includes:
presenting a display of a representation of a query flash card, the query flash card including a query; and
presenting a display of a plurality of selectable responses to the query via a plurality of representations of answer flash cards.

10. An authoring tool for enhancing long-term memory, the authoring tool comprising:
means for providing a graphical user interface input for receiving content;
means for receiving the content, the received content including at least one query input and associated response; and
means for formatting the content for use with a query and response feature;
wherein the query and response feature includes:
means for providing each of the at least one query, each of the at least one query having an associated memory retention value;
means for receiving a response to each of the at least one query;
means for evaluating the response to each of the at least one query; and
means for updating the associated memory retention value for each of the at least one query based on the response to the evaluated response.

11. A device for providing an authoring tool for enhancing long-term memory, the device comprising:
a display for displaying various elements;
a processor for receiving selections, for processing selections, and for processing and displaying a graphical user interface; and
a graphical user interface input device for receiving content;
wherein the content is received, the received content including at least one query input and associated response;
wherein the content is formatted via the processor for use with a query and response feature,
wherein each of the at least one query is presented via the display, each of the at least one query having an associated memory retention value;
wherein a response is received to each of the at least one query;
wherein the response to each of the at least one query is evaluated; and
wherein the associated memory retention value for each of the at least one query is updated based on the response to the evaluated response.

12. The device of claim 11, wherein the device comprises a terminal.

13. The device of claim 12, wherein the terminal comprises one selected from a group consisting of a personal computer, a minicomputer, a microcomputer, a main frame computer, and a slot machine.

14. The device of claim 11, wherein the display is coupled to a display processor, the display and display processor comprising a display terminal.

15. The device of claim 14, wherein the display terminal is coupled to the processor via a network.

16. The device of claim 15, wherein the network is the Internet.

17. A method for providing a multimedia output via an authoring tool, the method comprising:
receiving a plurality of multimedia data feeds;
providing at least one option for combining the multimedia data feeds;
receiving at least one selection for combining the multimedia data feeds;
formatting the combined multimedia data feeds; and
producing the multimedia output form the combined multimedia data feeds.

18. The method of claim 17, wherein the multimedia output is a compact disk containing data.

19. The method of claim 17, wherein the plurality of multimedia data feeds includes a voice over stream.

20. The method of claim 17, wherein the plurality of multimedia data feeds includes at least one video stream.
